(19) United States
(12) Patent Application Publication
(10) Pub. No.: US 2020/0148811 A1
(43) Pub. Date: May 14, 2020

(54) SULFANILAMIDE CONTAINING EPOXY RESIN COMPOSITIONS

(71) Applicant: Dow Global Technologies LLC, Midland, MI (US)

(72) Inventors: Timothy A. Morley, Schirtdeliegi (CH); Rainer Koeniger, Horgen (CH); Luca Lotti, Correggio (IT); Nebojsa Jeiic, Wangen (CH); Zeljko Sikman, Lachen (CH); Martin Reimers, Buehl-Rittersbach (DE)

(21) Appl. No.: 16/604,264

(22) PCT Filed: Apr. 11, 2018
(86) PCT No.: PCT/US2018/027104

§ 371 Date: Oct. 10, 2019

Related U.S. Application Data
(60) Provisional application No. 62/503,975, filed on May 10, 2017.

(51) Int. Cl. C08G 59/46; C08G 59/50

(52) U.S. Cl. CPC C08G 59/46; C08G 59/5026; C08G 59/502

(57) ABSTRACT

A novel sulfanilamide containing epoxy resin composition capable of fast curing without negative impact on glass transition temperature or mechanical performance.

A fast curing performance window is critical for the mass production of carbon and glass fiber based applications such as structural automotive body components and other composite applications. For example, when considering glass fiber suspension applications versus body structures, there is typically a larger impact of the resin composition on the mechanical performance of the final composite, hence the resin composition should be carefully designed to obtain a good mechanical performance in the composite while maintaining a high cure speed.

A well-known route to improve the thermal and mechanical performance in epoxy-based compositions is to include cycloaliphatic or aromatic amine based compounds into the hardener composition. While this can improve many aspects of performance such as, for instance, generating materials with a higher glass transition temperature and an improved tensile and shear performance, the speed of cure is often significantly lengthened as a consequence. Furthermore, aromatic amines often possess EH&S concerns, and are frequently highly colored. When in solid form, aromatic amines can be difficult to dissolve, especially when liquid based compositions are required in processing applications such as resin transfer molding (RTM) and liquid compression molding (LCM). To counter negative effects on curing time, compounds designated as “accelerators” can also be included in the resin composition. These are compounds which increase the rate of catalyzed reactions but are themselves not catalysts. To this end, tertiary amine, phenolic or carboxylic acid based accelerators are very effective and often used in amine based compositions. Their presence, however, can have a detrimental effect on thermal and mechanical performance, i.e. a reduction in glass transition temperature and lower tensile and shear performance.

This problem has been solved via the use of a hardener composition containing the molecule sulfanilamide as an accelerator, which has surprisingly been found to dissolve well in triethylenetetramine (TETA) producing a required liquid curing agent, able to be used on common injection equipment. When the solution of TETA and sulfanilamide has been further mixed with a suitable catalyst and optionally a cycloaliphatic amine moiety to form the hardener, then subsequently reacted with an epoxy resin, a significantly faster curing epoxy composition could be obtained while not impacting glass transition temperature or mechanical performance in terms of interlaminar shear strength (ILSS).

The hardener composition of the present invention has a viscosity about 0.1 to 100,000 mPa·s, preferably about 1 to 60,000 mPa·s; more preferably about 1 to 30,000 mPa·s, and most preferably about 1 to 10,000 mPa·s. The viscosity is measured by placing the sample in a rheometer (MCR301, Anton Paar) equipped with parallel plates (25 mm diameter, gap 1 mm) maintained under isothermal conditions at 25° C. then measuring with a rotational speed [1/s] of 10 s⁻¹

### BRIEF DESCRIPTION OF THE DRAWINGS

FIG. 1 illustrates the impact of sulfanilamide on Tg, Gel Time and ILSS.

The present invention relates to curable compositions comprising heat resistant fibers, such as carbon fiber, glass fiber or their admixture, a two component resin mixture of (i) one or more epoxy resin compositions, such as bisphenol-A or bisphenol-F diglycidyl ether epoxy resins, and (ii) a hardener composition comprising a combination of a) a hardener such as triethylenetetramine (TETA), b) from 0.1 to 15 wt.-%, based on the weight of the TETA, of a catalyst such as 2-phenylimidazole (2-PI) or 1,4-diazabicyclo[2.2.2]octane (“DABCO”), c) from 0.1 to 60 wt.-%, based on the weight of the TETA, of an accelerator, e.g. sulfanilamide such as one commercially available from Hunan Chemicals BV and d) from 5 to 60 wt.-% of a cycloaliphatic amine. The present composition has been found to be capable of curing at high speeds even down to 60 seconds while providing a high glass transition temperature of more than 120° C. and producing composites from said composition with an improved interlaminar shear performance versus those prepared via more widely used fast curing epoxy resin systems.

Many different epoxy resin compositions may benefit from the present invention. For example, Epoxy Resin A, as shown in the examples, which is a diglycidyl ether of bisphenol A, having an epoxide equivalent weight of 180 g/eq and contains about 0.5% by weight of monohydrolyzed species, may be used as the epoxy resin composition to be mixed with the hardener composition of the present invention.

As mentioned above, there are a number of widely used aromatic based amine hardener compositions. They all have some undesirable features such as insolubility in other compatible chemicals, and unfavorable EH&S profile. Sulfanilamide, containing a chemical structure as illustrated below by structure I, is generally considered to have a low EH&S profile and has been found to be highly soluble in triethylenetetramine leading to formulations displaying improved mechanical performance when used to prepare a composite article, whilst at the same time displaying the ability to achieve a fast curing time.

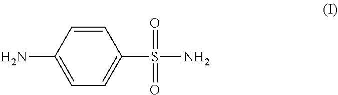 [SMILES: Nc1ccc(S(N)(=O)=O)cc1]

Table 1 illustrates the comparison of sulfanilamide with some other aromatic amines.

TABLE 1
Comparison between sulfanilamide and other commonly used
aromatic hardeners.

| | Physical | Solubility in | EH&S |
|---|---|---|---|
| Structure | form (mpt ° C.) | TETA | Description |
| 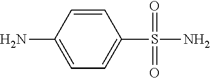 [SMILES: Nc1ccc(S(N)(=O)=O)cc1] | Crystalline Solid (164- 166) | High | Low EH&S Profile |
| 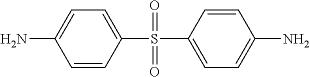 [SMILES: Nc1ccc(S(=O)(=O)c2ccc(N)cc2)cc1] | Crystalline Solid (175- 177) | None | Harmful |
| 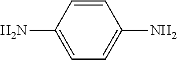 | Solid flakes (138-143) | Not tested due to toxicity | Toxic |
| 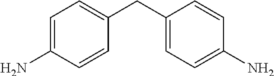 [SMILES: Nc1ccc(Cc2ccc(N)cc2)cc1] | Solid flakes (88-92) | Not tested due to toxicity | Toxic May cause cancer |

In one embodiment of the present invention, the hardener composition comprises, based on the weight of the hardener composition, about 1 to 100 wt.-%, preferably from 10 to 90 wt.-%, and more preferably from 20 to 90 wt.-% of TETA; about 0.1 to 60 wt.-%, preferably from 0.5 to 50 wt.-%, and more preferably from 1 to 40 wt.-% of sulfanilamide; about 5 to 60 wt.-%, preferably from 5 to 50 wt.-% and more preferably from 10 to 40 wt.-% of isophoronediamine (“IPDA”) or other cycloaliphatic amines; and a catalyst such as 1,4-diazabicyclo[2.2.2]octane (“DABCO”) in the amount of 0.1 to 15 wt.-%, preferably from 1 to 15 wt.-% and more preferably from 1 to 10 wt.-%.

The hardener composition of the present invention may also contain a mixture of primary and/or secondary amine compounds.

Aminocyclohexanealkylamines constitute about 5 to 60 wt.-%, preferably 5 to 50 wt.-% and more preferably 10 to 40 wt.-% of the weight of the primary and/or secondary amino compounds in the hardener composition.
Aminocyclohexanealkylamines are substituted cyclohexanes that have an amino substituent and an aminoalkylsubstitutent on the cyclohexane ring. Among the useful aminocyclohexanealkylamine compounds are those represented by structure II:

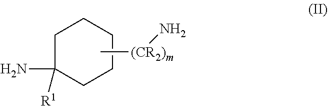

wherein R¹ is C₁-C₄ alkyl, each R is independently hydrogen or C₁-C₄ alkyl and m is a number from 1 to 8. Each R group in structure II is preferably independently hydrogen or methyl, and R¹ is preferably methyl. In structure II, the —(CR₂)ₘ—NH₂ group may be positioned in ortho-, meta- or para- with respect to the amino group bonded directly to the cyclohexane ring. The —NH₂ and —(CR₂)ₘ—NH₂ groups in structure II may be in the cis- or trans-positions with respect to each other. In structure II, the cyclohexane carbon atoms may contain substituent groups in addition to the —NH₂, —R¹ and —(CR₂)ₘ—NH₂ groups shown inert with respect to the epoxy-amine reaction. A preferred initiator compound corresponding to structure I is cyclohexanemethanamine, 4-amino-α,α,4-trimethyl-(9Cl), which is also known as p-menthane-1,8-diamine or 1,8-diamino-p-menthane.

A second type of aminocyclohexanealkylamine corresponds to structure III:

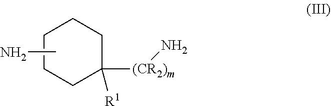

in which R, R₁ and m are as defined before. As in structure II, each R group in structure III is preferably independently hydrogen or methyl and R¹ is preferably methyl. In structure III, the —(CR₂)ₘ—NH₂ group may be positioned in ortho-, meta- or para- with respect to the amino group bonded directly to the cyclohexane ring. The —NH₂ and —(CR₂)ₘ—NH₂ groups in structure III may be in the cis- or trans-positions with respect to each other. In structure III, the cyclohexane carbon atoms may contain inert substituent groups in addition to the —NH₂, —R¹ and —(CR₂)ₘ—NH₂ groups shown. An especially preferred initiator compound that corresponds to structure III is 5-amino-1,3,3-trimethylcyclohexanemethylamine (isophorone diamine).

The present invention also provides, as another aspect, a resin composition that comprises, all based on the total weight of the resin composition
1) 1 to 100 wt.-%, preferably 30 to 100 wt.-%, and more preferably 40 to 100 wt.-% of Epoxy Resin A which is a diglycidyl ether of bisphenol-A, having an epoxide equivalent weight of about 180 g/eq and contains about 0.5% by weight of monohydrolyzed species;
2) 1 to 100 wt.-%, preferably 10 to 80 wt.-%, and more preferably 20 to 70 wt.-% of Epoxy Resin B which is a digycidyl ether of bisphenol-A containing core shell rubber particles 15%, EEW ˜180 g/eq commercially available from Olin Corp. as FORTEGRA™ 301;
3) 1 to 100 wt.-%, preferably 10 to 80 wt.-%, and more preferably 20 to 70 wt.-% of Epoxy Resin C which is a digycidyl ether of bisphenol A containing core shell rubber particles 25 wt.-% with respect to the diglycidyl ether of bisphenol-A, EEW ˜180 g/eq commercially available from Kaneka Corp. as Kane Ace MX-170;
4) 1 to 100 wt.-%, preferably 10 to 90 wt.-%, and more preferably 20 to 80 wt.-% of Epoxy Resin D which is a diglycidyl ether of bisphenol-F, having an epoxide equivalent weight of about 171 g/eq.;
5) 1 to 100 wt.-%, preferably 10 to 90 wt.-%, and more preferably 20 to 80 wt.-% of Epoxy Resin E which is a mixture of diglycidyl ether of bisphenol-F and diglycidyl ether of bisphenol-A resin, having an epoxide equivalent weight of about 172 g/eq.;
6) 1 to 100 wt. %, preferably 10 to 90 wt.-%, and more preferably 20 to 90 wt.-% of TETA with AHEW value of 24.4 g/eq commercially available from The Dow Chemical Company;
7) 0.1 to 15 wt.-%, preferably 1 to 15 wt.-%, and more preferably 1 to 10 wt.-% of 2-phenylimidazole (“2-PI”) with CAS No. 670-96-2, commercially available from Hunan Chemicals BV;
8) 0.1 to 15 wt.-%, preferably 1 to 15 wt.-%, and more preferably 1 to 10 wt.-% of triethylenediamine or DABCO, CAS 280-57-9, commercially available from Air Products;
9) 0.1 to 60 wt.-%, preferably 0.5 to 50 wt.-%, and more preferably 1 to 40 wt.-% of sulfanilamide, commercially available from Hunan Chemicals BV.

Other commonly used chemicals may also be used as additional functional components or in lieu of above listed compounds. One example is a typically used cycloaliphatic amine such as 4,4′-methylenebis(cyclohexylamine), CAS 1761-71-3 which is commercially available from Air Products as Amicure™ PACM (“PACM”).

A typical epoxy resin composition may also contain some fillers, or other functional chemicals for any intended applications.

The present invention is further illustrated with some non-limiting examples as shown below.

AHEW means the amount in grams of an amine that yields one molar equivalent of hydrogen in reaction as measured by titration using ASTM D 2074-07 (2007).

“EEW” or “epoxy equivalent weight” means the amount in grams of an epoxy resin that yields one molar equivalent of epoxy groups in reaction with amines, determined using a Metrohm 801 Robotic USB sample processor XL and two 800 Dosino™ dosing devices for the reagents (Metrohm USA, Tampa, Fla.). The reagents used are perchloric acid in acetic acid 0.10 N and tetraethylammonium bromide. The electrode for the analysis is an 854 Iconnect™ electrode (Metrohm). For each sample, 1 g of dispersion is weighed out into a plastic sample cup. Then 30 mL of THF (tetrahydrofuran) is first added and mixed for 1 minute (min) to break the shell on the dispersion. Next, 32 mL of glacial acetic acid is added and mixed for another 1 min to fully dissolve the sample. The sample is then placed on the auto sampler and all relevant data (e.g., sample ID, sample weight) is added to the software. From here the start button is clicked to start the titration. Thereafter, 15 mL of tetraethylammonium bromide is added, and then the perchloric acid is slowly added until a potentiometric endpoint is reached. Once the potentiometric endpoint is reached, the software calculates an EEW value based on the amount of sample and perchloric acid used.

“DSC Glass Transition Temperature Tg” means the glass transition temperature of a given material. Dynamic DSC was used to determine the T_{g} value of the composition. To measure the glass transition temperature, samples were first heated in a heating ramp of +20° C./min from 25-200° C. The sample cell is kept isothermal at 200° C. for three minutes, cooled in a ramp of −20° C./min down to 25° C., kept isothermal at 25° C. for three minutes, then heated again with a heating ramp of +20° C./min to 200° C., kept isothermal at 200° C. for 3 minutes, and cooled in a ramp of −20° C./min down to 25° C. T_{g} onset and T_{g} midpoint are determined from the second heating segment.

To demonstrate the advantages of the present invention, a hot plate experiment was conducted. Gel time and demold times are evaluated according to the following curing evaluation test: the epoxy resin (preheated to approximately 40° C.) and hardener mixture (at approximately 25° C.) are brought together in the required ratio then mixed for 30 seconds. The resulting mixture is poured onto a hot plate preheated to 90 or 130° C. to form a disk of liquid on the surface of the plate. Time is measured from the point at which the mixture contacts the hot plate surface. The hot plate is maintained at 90 or 130° C. as the mixture cures. A line is scored through the liquid disk periodically, using a wooden pallet knife or similar blade. The gelation time (GT) is the time after which the liquid material would no longer flow into the scored line. Demold time (DMT) is the time after pouring at which the disk can be removed from the hot plate surface as a solid, using the pallet knife or similar blade.

Inter Laminar Shear Strength (ILSS) measurements were run on a Zwick® dynamometer and measured by a three point bending test according to EN ISO 14130. σₘ was determined at the maximum of stress at failure or at end of test according to the norm.

TABLE 2
Impact of sulfanilamide on Tg, Gel Time and ILSS

| | Invent 1 | Invent 2 | Comp 1 | Invent 3 | Invent 4 | Comp 2 |
|---|---|---|---|---|---|---|
| TETA | 56.8 | 65 | 75 | 36.8 | 45 | 55 |
| Sulfanilamide | 18.2 | 10 | | 18.2 | 10 | |
| PACM | 20 | 20 | 20 | 40 | 40 | 40 |
| DABCO | 5 | 5 | 5 | 5 | 5 | 5 |
| Resin:Hardener | 1:1 | 1:1 | 1:1 | 1:1 | 1:1 | 1:1 |
| Stoichiometry | | | | | | |
| Tg (° C.) | 135 | 139 | 135 | 138 | 135 | 120 |
| Gel Time (s) @ | 90 | 160 | 180 | 120 | 150 | 195 |
| 90° C. plate | | | | | | |
| Temperature | 58 | 60 | 61 | 57 | 62 | 63 |
| ILSS (MPa) | | | | | | |

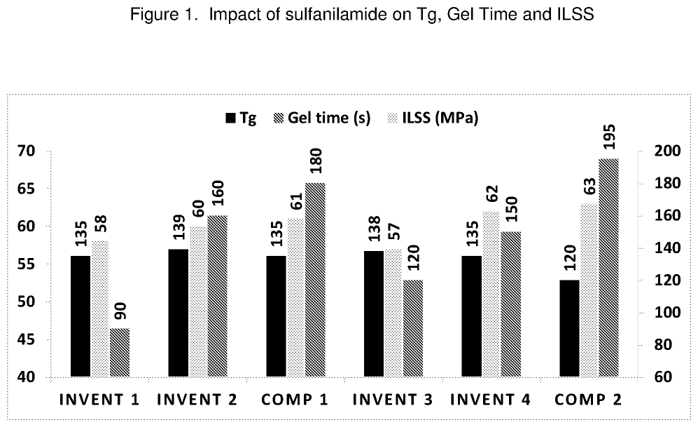

As shown in FIG. 1 and Table 2, Comparative Example 1 shows the properties achieved from reacting Epoxy Resin A with a representative hardener formulation containing, with amounts shown in Table 2, an aliphatic amine triethylenetetramine (TETA), a cycloaliphatic amine (4,4′-methylenebis(cyclohexylamine)) with a triethylenediamine catalyst. Glass fiber composite parts made from these resin compositions were produced using the wet compression (LCM) method with a preform consisting of 4 layers unidirectional glass fiber from 3B W3030.

It can be concluded that, from Inventive Examples 1 and 2 which contain sulfanilamide, a significantly faster gel time can be obtained without any loss of thermal or mechanical performance in a composite article. This effect is further demonstrated via Comparative Example 2 wherein a higher level of cycloaliphatic amine is used. Inventive Examples 3 and 4 once again demonstrate that faster gelation times can be obtained via the addition of the sulfanilamide without degradation of the other key performance attributes. The increased gelation time and cure speed of these compositions exhibiting higher thermal and mechanical performance can be of particular use in composites where higher performance is required yet a mass production scenario is desired.

Additional Inventive Examples and Comparative Examples were prepared to further demonstrate the effectiveness of the present invention as shown in Tables 3 and 4 with Table 4 summarizing the details of the various tested compositions. Carbon fiber composite parts made from these resin compositions were produced using the wet compression (LCM) method with a preform consisting of 6 layers unidirectional carbon fiber from DOWAKSA, CL 300 E 10 B.

TABLE 3
Comparative and Inventive Examples Formulations and Results

| | | Comparative | | | | | | |
|---|---|---|---|---|---|---|---|---|
| | | Example B | | | | | | |
| | Comparative | (′246 | Inventive | Inventive | Comparative | Comparative | Comparative | Comparative |
| | Example A | application) | Example A | Example B | Example C | Example D | Example E | Example F |
| Resin | A | A | A | A | B | C | D | E |
| Hardener | TETA | TETA | TETA | TETA | TETA | TETA | TETA | TETA |
| Description | (93%) | (93%) | (66.5% | (66.5%) | (93%) | (93%) | (93%) | (93%) |
| | | | Sulfanilamide | Sulfanilamide | | | | |
| | | | (28.5%) | (28.5%) | | | | |
| Catalyst | DABCO | 2-PI | DABCO | 2-PI | DABCO | DABCO | DABCO | DABCO |
| | (7%) | (7%) | (5%) | (5%) | (7%) | (7%) | (7%) | (7%) |
| Resin:Hardener | 1:1 | 1:1 | 1:1 | 1:1 | 1:1 | 1:1 | 1:1 | 1:1 |
| Stoichiometry | | | | | | | | |
| Glass Transition | 125 | 138 | 135 | 133 | 124 | 120 | 106 | 108 |
| DSC Mid Pt, ° C. | | | | | | | | |
| ILSS (MPa) | 71 | 72 | 85 | 78 | 58 | 70 | 78 | 80 |
| UD fabric | | | | | | | | |
| ISO 14130 | | | | | | | | |
| Demold Time | 120 | 120 | 120 | 120 | 240 | 240 | 240 | 240 |
| (s) | | | | | | | | |
| Gel Time (s) | 36 | 37 | 35 | 38 | — | — | — | — |
| as measured | | | | | | | | |
| on a | | | | | | | | |
| Hot plate @ | | | | | | | | |
| 130° C. | | | | | | | | |

Comparative Example A from Table 3 lists the performance characteristics of an epoxy system where DABCO has been used as the catalyst component, versus Comparative Example B where the DABCO catalyst has been exchanged for 2-phenylimidazole giving a higher glass transition temperature as described in U.S. Provisional Patent Application No. 62/341,246 with a filing date of May 25, 2016 (the “246 application”), incorporated herein by reference in its entirety. Inventive Examples A and B are then equivalent compositions to Comparative Examples A and B, respectively, with the only difference being the addition of the sulfanilamide to the composition as shown in Table 3. All compositions are tested via the manufacture of a carbon fiber composite part with a 1:1 stoichiometric ratio of epoxy to amine functionality. It is noted that, via the addition of the sulfanilamide to these compositions, the gel time remains relatively constant (an important feature for mold filling and fiber wetting) and the inter laminar shear strength (ILSS) is improved, while maintaining or improving (Comparative Example A vs Inventive Example A) glass transition temperature with a consistent cure time of 120 seconds.

In an attempt to improve the ILSS of Comparative Example A versus that of inventive Examples A and B while maintaining a high glass transition temperature and speed of reaction, further more widely known approaches were investigated. These included the addition of core shell rubber particles (Comparative Examples C and D) and by evaluating alternative resins (Comparative Examples E and F) to that of the diglycidylether of bisphenol-A resin used for Comparative and Inventive Examples A and B.

In the case of the addition of core shell rubber particles, two types were evaluated from different suppliers in Comparative Examples C and D, respectively. Neither of the approaches was found to have a beneficial effect on the ILSS performance of the final composite a77 yd either resulted in a drop of ILSS while maintaining glass transition temperature (Comparative Example C) or maintaining ILSS but decreasing glass transition temperature (Comparative Example D).

In order to improve the ILSS of Comparative Example A versus that of Inventive Examples A and B while maintaining a high glass transition temperature and speed of reaction, additional alternative epoxy resins were evaluated as shown by Comparative Examples E and F. In particular, bisphenol-F based resins particularly with low functionality are well known to increase the flexibility of resin systems and with Comparative Example E a pure bisphenol-F based resin was utilized, whereby in Comparative Example F a low functionality Novolac resin was employed. From Comparative Examples E and F, it is noted that in both cases improvements of ILSS were found. However, the use of these epoxy resins caused a substantial decrease in the glass transition temperature of the material produced.

When comparing Comparative Examples A-F and Inventive Examples A and B, it is noted that the addition of sulfanilamide demonstrates an improvement in ILSS as well as at least maintaining glass transition temperature and cure speed. Furthermore the composition and process benefits from being a liquid based hardener due to the discovered solubility of the sulfanilamide in the triethylenetetramine.

The composite article containing the hardener composition of the present invention may also comprise one or more impact modifiers, internal mold release agents, reactive diluents, coalescents, pigments, dyes, particulate fillers, extenders, tackifiers, antioxidants and wetting agents as can be routinely selected by one of ordinary skilled in the art.

What we claim:

1. A liquid based hardener composition comprising a catalyst, an amine based hardener, and a sulfanilamide containing a chemical structure of

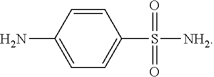 [SMILES: Nc1ccc(S(N)(=O)=O)cc1]

2. The hardener composition of claim 1 wherein the catalyst comprises at least one of 2-phenylimidazole and 1,4-diazabicyclo[2.2.2]octane.

3. The hardener composition of claim 1 wherein the amine based hardener comprises triethylenetetramine.

4. The hardener composition of claim 1 further comprising a mixture of primary and secondary amine compounds.

5. The hardener composition of claim 4 wherein the mixture comprises aminocyclohexanealkylamine.

6. The hardener composition of claim 1 comprising, based on the total weight of the hardener composition, 0.1 to 15 wt. % of the catalyst; 1 to 100 wt. % of triethylenetetramine; and 0.1 to 60 wt. % of sulfanilamide.

7. The hardener composition of claim 6 further comprising 5 to 60 wt. % of a mixture of primary and secondary amine compounds.

8. An epoxy based resin composition comprising i) one or more epoxy resins; and ii) a sulfanilamide containing hardener composition.

9. A composite article comprising a hardener composition of claim 1.

10. The composite article of claim 9 further comprising one or more impact modifiers, internal mold release agents, reactive diluents, coalescents, pigments, dyes, particulate fillers, extenders, tackifiers, antioxidants and wetting agents.
